(19) United States
(12) Patent Application Publication
(10) Pub. No.: US 2018/0216779 A1
(43) Pub. Date: Aug. 2, 2018

(54) SPORTS BOARD HANGING SYSTEM

(71) Applicant: Christopher Damiano, San Diego, CA (US)

(72) Inventor: Christopher Damiano, San Diego, CA (US)

(21) Appl. No.: 15/419,849

(22) Filed: Jan. 30, 2017

(51) Int. Cl. F16M 13/02; F16M 11/04; F16M 11/14

(52) U.S. Cl. CPC F16M 13/02; F16M 11/14; F16M 11/041

(57) ABSTRACT

A mounting system for sports boards such as surfboards, paddleboards, and snowboards is provided for holding the sports board elevated for storage and display. The device includes a support mount which is engageable to a support surface such as a wall. A board mount is provided which is configured at one end to removably engage the support mount. The opposite end of the board mount is adapted for removable engagement to a connector on the sports board such as a finbox. A mid portion of the board mount may include a pivot to allow pivoting of the engaged board while being supported by the device.

### BACKGROUND OF THE INVENTION

### Field of the Invention

The present invention relates generally to sports boards such as surfboards, skis, snowboards and similar riding platforms used in sports. More particularly, the invention relates to a device and method for hanging such sports boards when not in use which allows for elevated positioning of the board while temporarily engaged with a wall or similar surface.

### Prior Art

Sports boards are widely used throughout the world for both competition and for recreational enjoyment. Such sports boards include a wide variety of platforms such as surfboards, skis, snowboards, wake-boards, skim-boards, skateboards, boogie boards, sailboards, and wake surfboards.

Once the riding of such sports boards ceases, users will generally return them to their home where they are stored until the next duration of recreation by the user. Conventionally, when their sports boards are not being used, some owners of sports boards will position their sports board to lie upon a floor or other surface, or lean against a wall of their home or garage. Other sports board owners have been known to employ a hanger or belt to support their sports board above a floor surface in an elevated position, or position them on racks or the like.

Most such sports board equipment is highly engineered for a particular riding purpose or regimen. Consequently, such boards can cost many hundreds, and in some cases thousands, of dollars. However, the improper storage of such sports boards, where they can fall from a leaning position or be stepped upon by accident, can result in significant damage to the board. Such damage can result in cracking, scratching, denting, and other damage which can ruin the riding characteristics of the board or in some cases render the sports board useless. Where repairs are possible to such damaged sports boards, they can result in significant cost to the owner.

Retailers and manufacturers of such sports boards face a similar problem. In order to sell such sports boards they must be displayed. However, such displaying results in the leaning of sports boards against walls, or positioning them upon floors. While such sports boards may be placed on shelves or racks, such is not conducive to viewing by potential buyers, and the constant removal and replacements of such sports boards upon shelf and rack surfaces can result in the same denting and scratching and other damage. Further, in the case of larger sports boards, such as sailboards or the like, the falling of a leaning board or improper removal from a high shelf, can cause injury to persons situated below, in addition to severe damage to the board itself.

As such, there exists a continuing unmet need for a secure and easy to employ mounting system for sports boards when not in use by owners, or when displayed by retailers and manufacturers. Such a system should allow for a secure elevated positioning of the sports board above the floor surface of a home or business to maintain the floors clear for walking and sitting and the like and prevent stepping upon the stored sports board. Such a system should provide for easy removable engagement of the board to a mount which is secure. Such a system should be easily adapted to provide a mount engageable to the existing or provided hardware of the board itself, which will not interfere with the performance characteristics of the sports board when used. Still further, such a mounting system should allow manufacturers and owners to display their sports boards by allowing for easy removable engagement with a wall or ceiling in a manner that the owner or a potential buyer, can admire and view the sports board view, inspect and admire the sports board. Finally, such a sports board mounting system should be easily adaptable to a wide plurality of sports boards at low cost.

The forgoing examples of related art, as to sports boards, such as surfboards or snowboards or the other noted sports boards, and the limitations related therewith are intended to be illustrative and not exclusive, and they do not imply any limitations on the invention described and claimed herein. Various limitations of the related art of sports board storage and display will become apparent to those skilled in the art upon a reading and understanding of the specification below and the accompanying drawings.

### SUMMARY OF THE INVENTION

The device herein disclosed and described provides a solution to the shortcomings in prior art with regard to the storage of sports boards in-between use and the display of sports boards offered for sale by retailers and manufacturers.

The device and system herein in all preferred modes features a wall mount adapted for secured engagement to a wall or ceiling or support member or other elevated structure. The wall mount is easily engaged to a fixed position using mount fasteners such as one or a combination of fasteners from a group including nails, screws, adhesive, hook and loop fabric, or other fasteners adapted to hold the mount to a wall or similar surface, while engaged with a sports board. While the term wall mount is used herein for convenience, it should not be considered limiting and as the cooperatively configured connection to the board mount, it can be positioned on other surfaces than a wall, such as posts, ceilings, cross members, support beams, or any elevated surface where the weight of the removably engaged board mount and board will be supported when connected to the wall mount.

Additionally employed in all modes of the system herein, is the board mount having a body adapted at a first end for a cooperative removable engagement with the wall mount. A second end of each board mount employed herein, is adapted for a removable engagement with the sports board. Preferably, in all modes of the device herein, the board mount is adapted at this second end, to removably engage with an existing structural component of the sports board. Again, as with the term wall mount, the term board mount, is employed for convenience and should not in any fashion be viewed as limiting. The board mount need not be engaged only with a surfboard or sail board but can be removably engaged to any sports board which has a connection adapted for removable engagement with the second end of the board mount.

One example employed herein and in the drawings, is configuring the second end of the body forming of the board mount, to a configuration which will engage within a recess formed into a sports board, such as that conventionally employed to engage a fin. Such recesses are widely employed for example on surfboards and sailboards in the form of fin boxes which are configured to removably engage with a fin used to steer the board during use in an aquatic environment.

However, any such description and depiction of adapting the second end of the board mount to removably engage with a fin recess or fin box of a surfboard or sailboard, should not be considered limiting in any fashion. The second end of the body of the board mount can be adapted to engage any structural component of any sports board in order to achieve a removable engagement therewith. Once so removably engaged with the sports board, the first end of the board mount can be removably engaged to the wall mount to hold the sports board in an elevated positioning for storage or display.

In some modes of the system herein, a pivoting connector is positionable between the first end of the board mount, and the second end of the board mount. Such a pivoting connector may be a hinge, a simple rotational engagement, or a ball and socket, or other pivoting connector. This pivot may be at any point between the first end and second end of the body of the board mount. In this mode of the device herein, once the first end of the board mount is removably engaged with the wall mount, and the second end of the board mount is removably engaged with the board, the board may be pivoted upon the pivoting connector to allow for better display of the sports board, or to allow for angling or positioning of the sports board on a wall or surface, in order to position one or more sports boards adjacent thereto, also in an engagement with a wall mount. Thus, a pivoting connection will allow owners of sports boards to angle or position them on a wall or beam or surface, to allow for other sports boards to be likewise mounted to the wall or support surface adjacent thereto. Further, such a pivoting connection will allow a manufacturer or retailer of such sports boards to pivot the mounted positioning of the sports board to a wall or beam or the like, to enhance viewing of potential buyers. Preferred pivoting connections include a ball and socket or a hinged connection, and in some modes of the device two pivoting connectors forming two pivoting connections might be included in the body of the board mount.

With respect to the above description, before explaining at least one preferred embodiment of the herein disclosed sports board mounting invention in detail, it is to be understood that the disclosed sports board mounting system is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed sports board storage and display mounting system. It is important, therefore, that the claims be regarded as including such equivalent construction and methodology insofar as they do not depart from the spirit and scope of the present invention.

The objects features and advantages of the present invention, as well as the advantages thereof over existing prior art, which will become apparent from the description to follow, are accomplished by the improvements described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative of the sports board mounting and display system herein, rather than limiting. In the drawings:

FIG. 1 shows a perspective view of one mode of the sports board mounting and display system herein, showing the support mount adapted for elevated engagement to a wall or beam or the like, and the board mount having a first end adapted to engage the support mount, and second end adapted to engage a recess in a sports board.

FIG. 2 shows the device as in FIG. 1, where the first end of the body of the board mount is adapted for cooperative removable engagement to the support mount, and the second end of the body of the board mount is shown in dotted line to indicate it may be adapted to engage any operative component of the sports board.

FIG. 3 depicts the sports board mounting and display system herein, showing a pivoting connector in the form of a hinge positioned in the body of the board mount between the first end and second end of the board mount, thereby allowing rotation along a line perpendicular to the pin of the hinge.

FIG. 4 depicts the sports board mounting and display system herein, showing a pivoting connector in the form of ball and socket positioned to engage between both ends of the body of the board mount thereby allowing rotation of the engaged sports board in multiple planes.

FIG. 5 shows a perspective overhead view depicting the engagement of the second end of the board mount to an operative engagement with a cooperatively configured recess in or on the sports board, such as the depicted fin box.

FIG. 6 shows a view of the sports board of FIG. 5, held elevated in a vertical disposition by the engagement of the first end of the board mount with a secured support mount.

FIG. 7 shows a view of the sports board of FIG. 5, held elevated in a horizontal disposition by the engagement of the first end of the board mount with a secured support mount.

FIG. 8 depicts a top plan view of the sports board mounting and display system herein where a co-operatively engaging connector adapted to engage the second end of the board mount, is provided as part of the system which is engaged with the sports board.

FIG. 9 depicts a sectional view though a sports board and a connector configured to removably engage the second end of the body of the board mount, showing a typical engagement of the board mount with a sports board.

FIG. 10 shows view of a connecter of the system herein, wherein it may be adjustable for length as well as configured with a biased engagement using the depicted spring or other modes of adjustable biased translation such as a rack and pinion set alone or in combination with a biasing component such as the depicted spring.

FIG. 11 shows a particularly preferred mode of the device herein having an eight sided support mount configured with a gap between opposing tabs which will engage over any two opposite sides of an eight sided connector of a board mount.

FIG. 12 shows a first end view of the board mount configured with an eight sided connector at the first end adapted to engage the eight sided support mount of FIG. 11.

FIG. 13 is a side view of the board mount of FIG. 12.

Other aspects of the present invention shall be more readily understood when considered in conjunction with the accompanying drawings, and the following detailed description, neither of which should be considered limiting.

### DETAILED DESCRIPTION OF THE PREFERRED

### Embodiments of the Invention

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

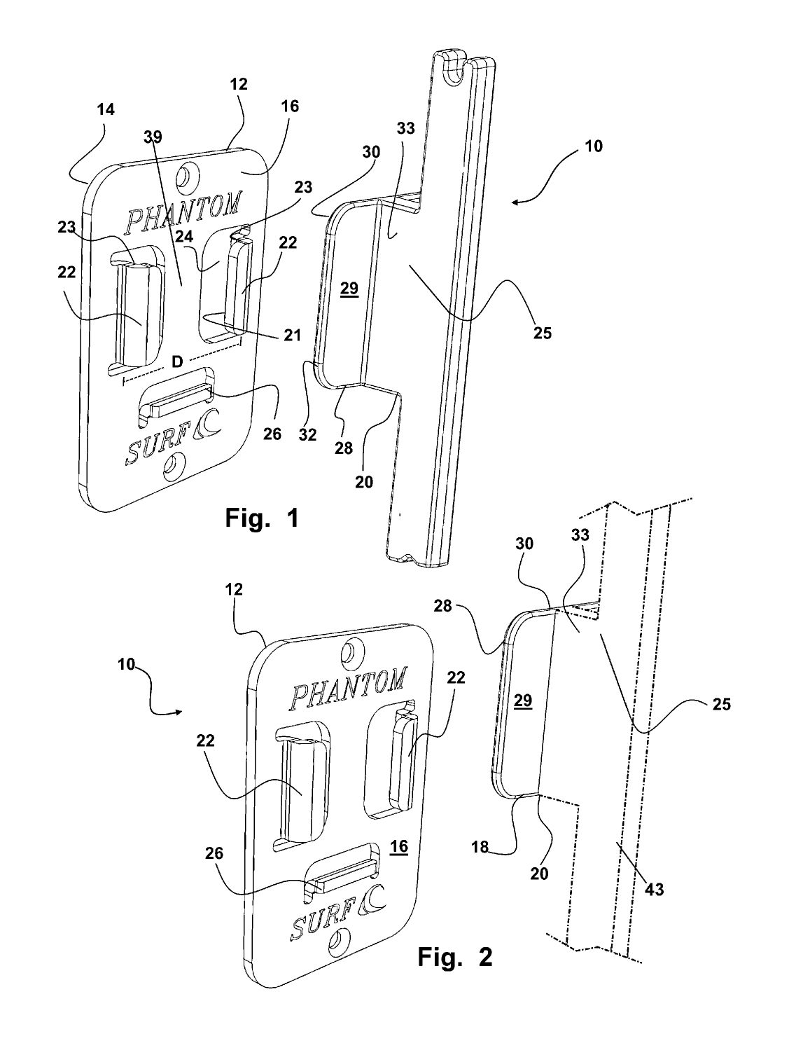

Now referring to drawings in FIGS. 1-13, wherein similar components are identified by like reference numerals, there can be seen in FIG. 1, a depiction of a separated configuration of the components of the device 10 herein. As shown there is the support mount 12 which is adapted for mounting on an elevated support surface such as a wall or beam or other surface adapted to hold the weight of an engaged sports board.

As shown in FIGS. 1-2, the support mount 12 has a planar body having a first surface 14 adapted for contact against the support surface, during engagement thereto such as with fasteners such as screws or nails. The support mount 12 has a second surface 16 having a first mating element configured to engage a second mating element positioned upon a first end of a body of a board mount 20, to achieve a removable engagement with a first end 18 of the body of a board mount 20.

In a favored mode of the device 10 herein, the support mount 12 configuration for this first mating element is a removable engagement provided by opposing tabs 22 projecting a distance away from the second surface 16 of the support mount 12. Each of the opposing tabs 22 has an interior surface 21 facing and spaced from the second surface 16 of the support mount 12 which defines a gap 24 formed between the second surface 16 of the support mount 12. Opposing facing side surfaces 23 of the two tabs 22 are separated by a distance D. The support mount 12 also has a projection 26 extending away from the second surface 16 of the support mount 12, which defines a stop for the translation of the connecting member 28 within a slot or gap 39 formed between the two tabs 22. This projection 26 can also be formed onto one or both of the tabs 22.

At the first end 18 of the body of the board mount 20, is positioned the second mating element. In a preferred mode of the device herein, the second mating element is provided by a planar connecting member 28 slidably engageable between the two tabs 22. The planar connecting member 28 has a first surface 29 and second surface 30 and having a width “W.” This width is just slightly less than the distance D between the side surfaces 23 of the tabs 22. A distance between the first surface 29 and the second surface 30 of the connecting member 28 defines a thickness of the connecting member 28 shown as sidewall 32. This thickness of the connecting member 28 is less than the size of the gap 24 between each tab 22 and the second surface 16 of the support mount 12.

A second end 25 of the board mount 20, is configured for operative removable engagement with a connector 27 of the sports board, such as for example, a connector 27 from a group of sports board connectors including a fin box for a surfboard or sail board, or a binding mount of a snow board. This second end 25 of the board mount 20 is separated from the connecting member 28 at a first end, by a central portion of the body forming the board mount 20. As shown for example herein, the second end 25 may be configured with an engagement member 43 adapted to operatively removably engage with the connector 27 of the sports board being hung or stored.

With the board mount 20, operatively engaged with a connector 27 on a sports board at the second end 25, using an engagement member 43 or other configuration, the connecting member 28 can be slide between the two tabs 22 extending from the second surface 16 of the support mount 12 opposite the projection 26 which forms a stop, and thereby into the engaged position. This forms a removable engagement of connecting member 28 within the respective gap 24 between each tab 22 and the second surface 16 of the support mount 12.

As the connecting member 28 slides into such a removable engagement, it will contact the projection 26, and thereby be positioned to the removable engagement. Disengagement from this engaged position, is accomplished by sliding the connecting member 28 and engaged board mount 20 in a direction toward the open end of the space between the two tabs 22 away from the projection 26 forming the stop. In a preferred mode of the device 10, the support mount 12 is adapted to be engaged to a support surface, with this open end between the tabs 22 opposite the projection 26, elevated higher than the projection 26, to thereby allow gravity acting on the engaged sports board, to hold the board mount 20 in the engaged position.

As can be discerned, with a sports board 34 operatively engaged with the appropriately configured second end 21 of the board mount 20, and with the support mount 12, operatively connected to a support surface, the connecting member 22 spaced a distance from the engaged sports board by a central portion 33 of the body of the board mount 20 is removably engageable with the support mount 12 this engaged position, in the fashion noted above. In this engaged position, the sports board connected to the board mount 20 is thus held in position connected to the support mount 12, and out of sight of viewers of the mounted sports board 34, which maybe mounted horizontally or vertically such as in FIGS. 6-7.

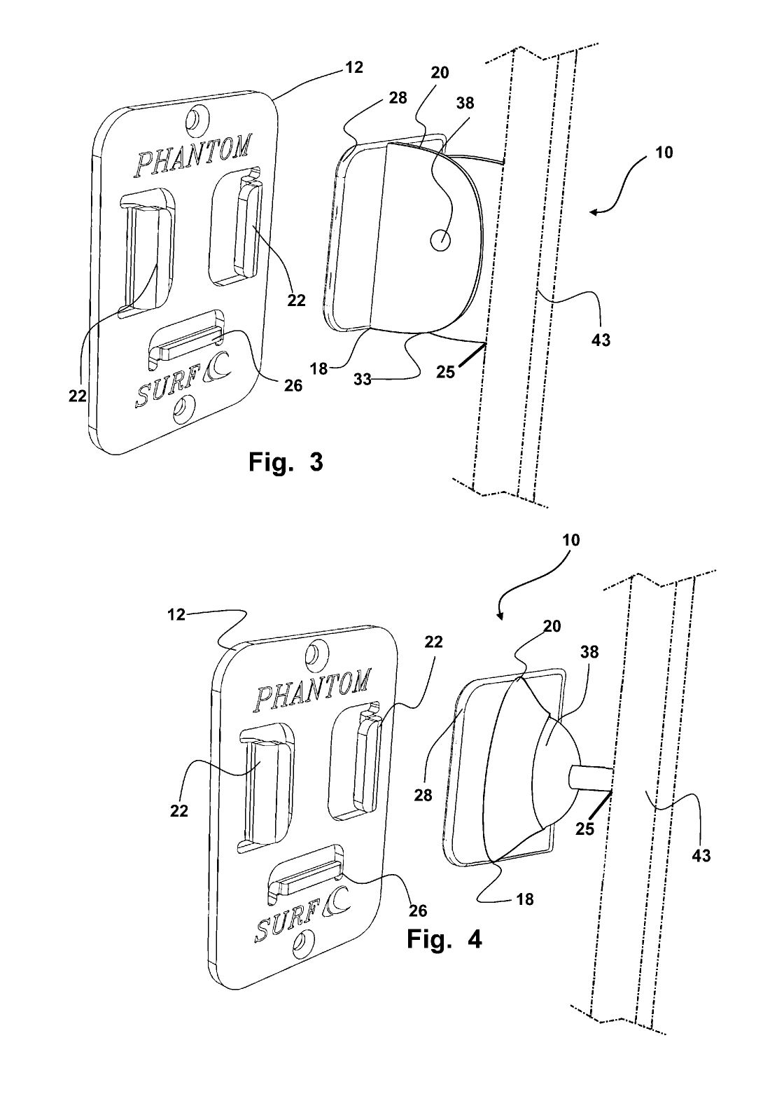

In FIG. 3, is shown the device with support mount 12 as in FIGS. 1-2, where a pivoting connector 38 shown as a hinge, is positioned in the central portion 32 the body of the board mount 20. So positioned between the first end 18 and second end 25 of the board mount 20, this pivot or pivoting connector 38 allows rotation along a line perpendicular to the pin of the hinge, and thereby will allow a sports board 34 having a connector 27 operatively engaged with the second end 25 of the body of the board mount 20 to also pivot.

In FIG. 4 is shown the device 10 herein, showing a pivoting connector 38 in the form of ball and socket, positioned at the central portion 33 of the body of the board mount 20. In this mode of the device 10, a rotation of the engaged sports board 34 can be accomplished along multiple planes. Such for example will allow angling of the plane of the engaged sports board 34, to mount it to a surface and allow vertical, horizontal, or diagonal positioning of the axis of the sports board 34 for display.

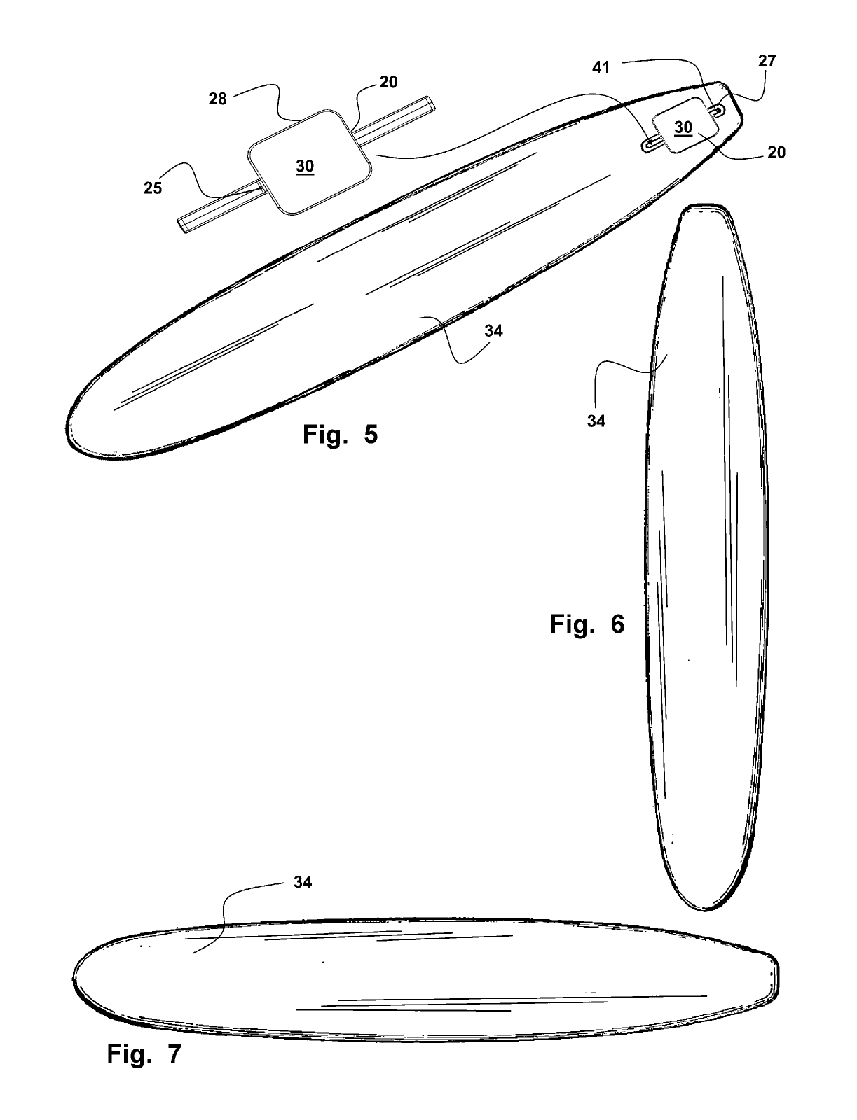

FIG. 5 depicts a perspective overhead view showing the formation of the removable engagement of the second end 25 of the board mount 20 with a complimentary configured sports board connector 27, such as a recess in or on the sports board, such as the depicted fin box mode of a connector 27 having a recess 41. The second end 25 may be formed into an engagement member 43 or in another shape of configuration complimentary to the shape of the connector 27.

FIG. 6 shows a view of the sports board 34 of FIG. 5, held elevated in a vertical disposition by the engagement of the first end of the board mount 20 with a secured wall mount 12. A horizontal disposition of the engaged sports board 34 is shown in FIG. 7.

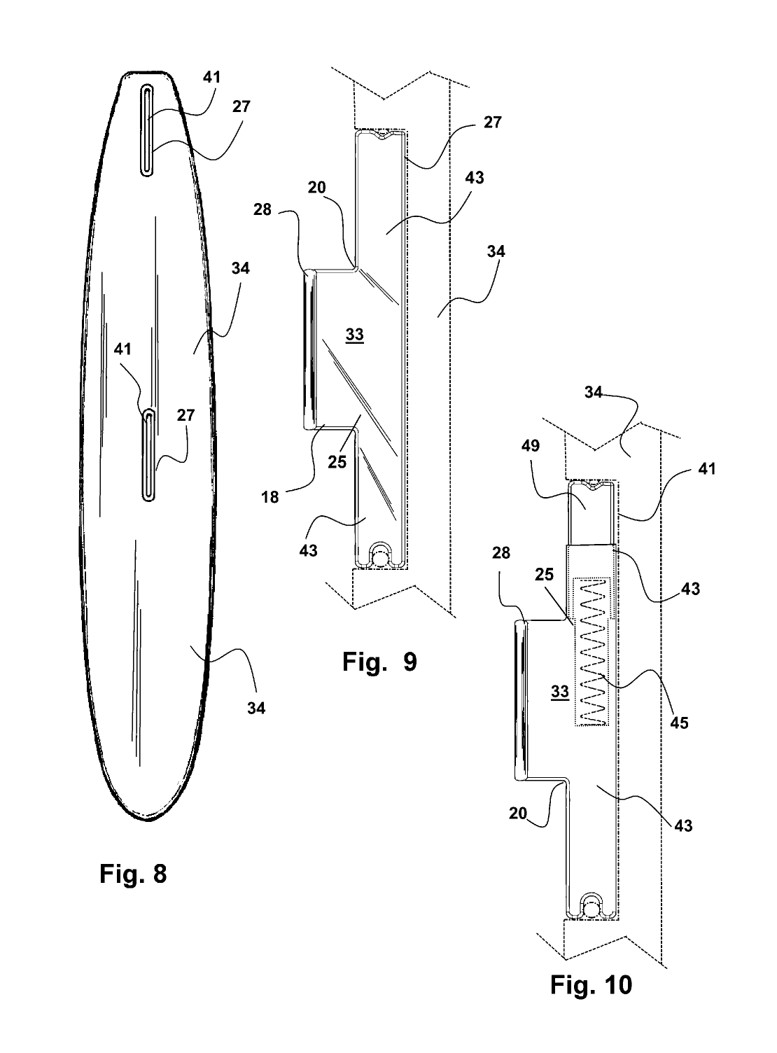

FIG. 8 depicts a top plan view of the sports board mounting and display system herein, where a co-operatively engaging connector 27, adapted to engage the complimentary shaped second end 25 of the board mount 20, is provided. This connector 27 would be included as part of the device 10 and provided to the user or manufacturer, where the complimentary shaped portion of the connector 27, such as a recess 41, will be engaged with the sports board 34. Such, for example, can be used by surfboard manufacturers, and mounted to the sports board during manufacture 27, to render it engageable to the device 10 herein for later elevate storage and/or display.

FIG. 9 depicts a sectional view though a sports board and portion of a sports board 34, showing a connector 27 having a complimentary shaped portion such as a recess 41, which is configured to removably engage with the shaped configuration of the second end 25 of the body of the board mount 20. As shown, a recess 41 formed into the connector 27, is shaped complimentary to an engagement member 43 formed on the second end 25 of the board mount 20. Of course this configuration can be reversed, or other configurations of the second end 25 of the body of the board mount 20 and connector 27 may be employed so long as they are complimentary in respective shape and size and allow for removable engagement therebetween.

For example, FIG. 10 shows the second end 25 of the body of the board mount 20, configured with an engagement member 43 which has one end 49 telescopically engaged with the body to translate and vary a length of the engagement member 43. A biasing component 45 continually biases the end 49 to translate in a direction away from the opposite end. This provides a second end 25 of the board mount 20 which is adjustable for length as well as configured to provide a biased engagement within a recess 41 or complimentary shaped area of the connector 27 of the sports board 34. The biased engagement can provide a means to maintain the second end 25 of the board mount 20 in removable engagement with a recess 41 formed within the connector 27 of a sports board 34.

In this mode of FIG. 10, the device 10 could be employed with existing sports boards 34 and the biased engagement of the second end of the 25 of the body of the board mount 20 could be configured to fit one or better, a plurality of the recesses 41 of different fin box type connectors 27, so that it would be easily employed on any connector 27 having a recess 41. Alternatively, a connector 27 could be included with the device 10 herein, which can be engaged to the sports board 34 of choice, and which has a recess 41 complimentary to the shape of the second end 25 of the board mount 20. Preferably with the mode of the device 10 including a connector 27, the biased engagement of FIG. 10 can be formed to engage the provided connector 27, which can be placed in a recessed engagement to the sports board 34, or in instances where a recessed positioning is not required, the connector 27 could be engaged using adhesive or the like. The spring loaded engagement of FIG. 10 this would be particularly easy to employ for both existing sports boards 34 with fin box type connectors 27, or by adhering a provided connector 27 adapted to engage easily and securely with the biased mode of the engagement of the device of FIG. 10.

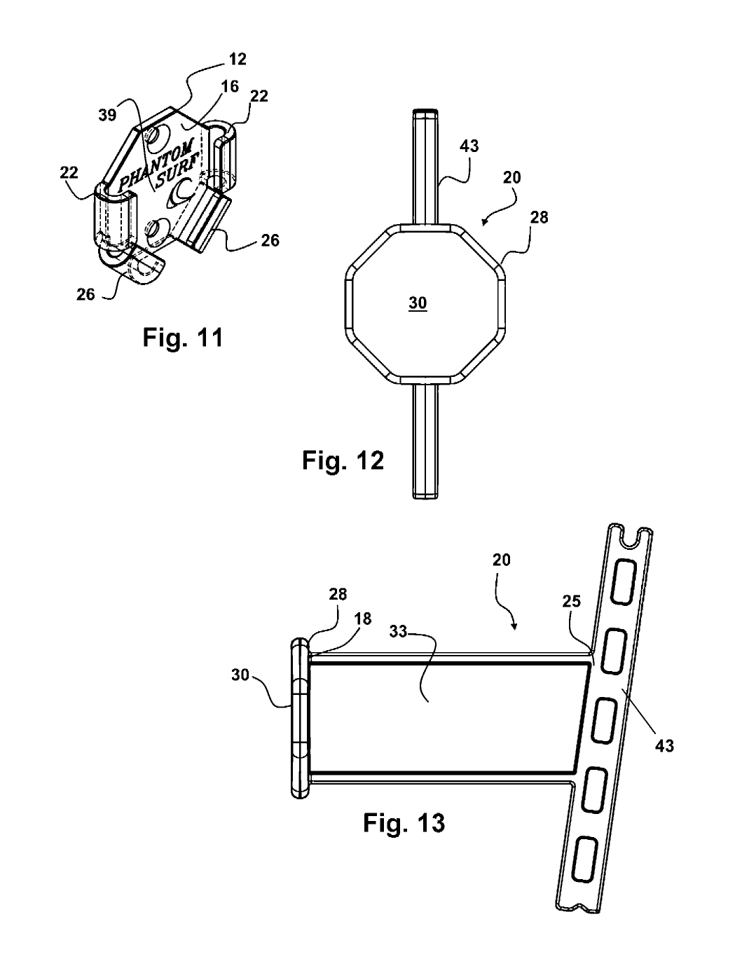

Shown in FIG. 11 is a particularly preferred mode of the device 10 herein because of the many angles of engagement provided between the eight sided support mount 12 which can be achieved with an board mount 20 as in FIG. 12 having a connecting member 28 with eight sides. As shown in FIG. 11, the eight sided support mount 12 has the gap 39 between opposing tabs 22 which will engage over any two opposite side edges from the plurality of eight sides on the connecting member 28 of a board mount 20 as in FIGS. 12 and 13. Of course the support mount 12 may be formed as a rectangle or other shape, so long as the tabs 22 are spaced apart to engage over opposing sides of an octagon or eight sided connecting member 28 of the board mount 20. However, forming both with the same shape is more aesthetically pleasing.

Forming the support mount 12 with tabs 22 spaced from each other and from the second surface 16 a distance to engage with opposing side surfaces of an eight sided board mount 20 in this configuration, lets the user position the engaged second end 25 of the board mount 20 into engagement with the support mount 12 at eight different angled positions. When engaged with a sports board 34, this multi angled engagement functionality thereby allows the user to put the sports board 34 in any of eight different angles when supported by the device 10. Such gives the user many options, especially where multiple sports boards 34 are all mounted to a wall or other vertical support, adjacent each other using one of the devices 10 herein as in FIGS. 11-13.

FIG. 12 shows a first end view of the board mount 20 configured with an eight sided connecting member 28 at the first end. This eight sided connecting member 28 is, as noted, adapted to engage the support mount 12 which has tabs 22 appropriately spaced to engage over opposing side surfaces of the connecting member 28, such as shown in FIG. 11 for example.

FIG. 13 is a side view of the board mount of FIG. 12. FIG. 13 also shows the second end 25 of the board mount 20, having an elongated engagement member 43 thereon adapting the shape of the second end 25 for engagement with a connector 27 on a sports board 34 having a complementary shaped recess 41 therein. The angled positioning of the axis of the formed member at the second end 25 of the board mount 20, will once engaged with the connector 27 on the sports board 34, angle the plane of the sports board 34 downward toward the floor supporting the wall or other support surface to with the support mount 12 is engaged.

Of course the support mount 12 as noted may be formed with an even number of sides which is less than or more than eight sides, so long as the tabs 22 are spaced to allow engagement therebetween by sliding the connector 28 into the gap 39.

Eight sides on the connecting member 28, having four pairs of opposing side surfaces, in experimentation, provided a superior number of angular possibilities than a configuration with less than eight sides, with each side still having sufficient length to securely engage between an opposing pair of tabs 22 on the support mount 12. However, it is envisioned that any configuration having from four sides to ten sides on the connector 28 can be employed to achieve the utility of a secure angular mounting of the board mount 20 and any secured sports board 34.

Other aspects of the present invention shall be more readily understood when considered in conjunction with the accompanying drawings, and the following detailed description, neither of which should be considered limiting

It should be noted and anticipated that although the sports board mounting and display device herein is shown in its most simple form, and shows engagements of the second end of the board mount to fin boxes and the like, various components and aspects of the device may be differently shaped to engage differently configures sports boards, or slightly modified when forming the invention herein. As such, those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the sports board mounting and display invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

1. A sports board mounting system, comprising:
a support mount, said support mount having a first surface opposite a second surface;
said support mount adapted for engagement to a support surface with said first surface facing said support surface;
a board mount having a body, said body having a first end, a second end, and having a central portion therebetween;
a pair of tabs extending from engagements with said support mount, said pair of tabs extending above said second surface of said support mount in opposing positions on said support mount;
a slot positioned between said pair of tabs, said slot extending to an open end;
a connecting member engaged at said first end of said body of said board mount;
said connecting member having a perimeter edge defined by an equal number of individual sides, said equal number of individual sides of said perimeter edge of said connecting member, defining a plurality of pairs of opposing said sides;
one said side of each respective said pairs of sides, being located on an opposite side of said perimeter edge of said connecting member, from the other said side of each respective said pairs of sides;
each said pair of opposing sides being positionable to a respective engagement with said pair of tabs by sliding of said connecting member into said slot; and
said second end of said body configured to removably engage with a connector positioned upon a sports board.

2. The sports board mounting system claim 1, wherein said second end of said body has an elongated engagement member thereon, said elongated engagement member extending along a line running between a first end and a second end thereof, said elongated engagement member configured to engage with a recess in a finbox defining the connector upon said sports board;
a rotation of said connecting member prior to said sliding of said connecting member into said slot, for positioning said connecting member to engage in different respective engagements of each respective pair of opposing sides of said connecting member, with said tabs, concurrently rotating said connecting member thereby rotating an angle of said line of said elongated member running between said fist and second end thereof; and
said engagement member being removably engageable with said recess of said finbox.

3. The sports board mounting system claim 1, additionally comprising:
a pivot positioned at said central portion of said body of said board mount.

4. The sports board mounting system claim 2, additionally comprising:
a pivot positioned at said central portion of said body of said board mount.

5. The sports board mounting system claim 1 additionally comprising:
a stop engaged to said support mount, said stop extending above said second surface of said support mount in a position opposite said open end.

6. The sports board mounting system claim 2 additionally comprising:
a stop engaged to said support mount, said stop extending above said second surface of said support mount in a position opposite said open end.

7. The sports board mounting system claim 3 wherein said first mating element positioned upon said second surface of said support mount comprises:
a pair of opposing tabs projecting a distance away from the second surface of said support mount;
a slot formed between said pair of opposing tabs;
said second mating element comprising a planar connecting member engaged at said first end of said body of said support mount; and
said planar connecting member removably engageable within said slot.

8. The sports board mounting system claim 4 wherein said first mating element positioned upon said second surface of said support mount comprises:
a pair of opposing tabs projecting a distance away from the second surface of said support mount;
a slot formed between said pair of opposing tabs;
said second mating element comprising a planar connecting member engaged at said first end of said body of said support mount; and
said planar connecting member removably engageable within said slot.

9. The sports board mounting system claim 3 wherein said pivot is a hinge.

10. The sports board mounting system claim 3 wherein said pivot is a ball and socket.

11. The sports board mounting system claim 4 wherein said pivot is a hinge.

12. The sports board mounting system claim 4 wherein said pivot is a ball and socket.

13. The sports board mounting system claim 7 wherein said pivot is a hinge.

14. The sports board mounting system claim 7 wherein said pivot is a ball and socket.

15. The sports board mounting system claim 8 wherein said pivot is a hinge.

16. The sports board mounting system claim 8 wherein said pivot is a ball and socket.

17. The sports board mounting system claim 1 additionally comprising:
said second end of said body shaped complimentary to a recess formed in said connector;
said second end of said connecter having a translating portion extending from one end between a recessed position and a projecting position;
a biasing component biasing said translating portion to said projecting position;
said second end of said body being removably engageable with said recess of said connector in a biased engagement of said second end therein.

18. The sports board mounting system claim 17 additionally comprising:
said connector being a fin box having a recess configured to operatively engage a fin for said sports board.

19. The sports board mounting system claim 1 additionally comprising:
said equal number of individual sides being between four and ten.

20. The sports board mounting system claim 1 additionally comprising:
said planar connecting member engaged at said first end of said body of said support mount being an octagon having eight said sides on said perimeter edge.
